(19) United States
(12) Patent Application Publication
(10) Pub. No.: US 2012/0133134 A1
(43) Pub. Date: May 31, 2012

(54) METHOD AND APPARATUS FOR DAMPING VIBRATIONS IN A WIND ENERGY SYSTEM

(75) Inventors: Hartmut SCHOLTE-WASSNIK, Lage (DE); Jacob Johannes NIES, Zwolle (NL)

(73) Assignee: General Electric Company, Schenectady, NY (US)

(21) Appl. No.: 13/296,813

(22) Filed: Nov. 15, 2011

(51) Int. Cl. H02P 9/04

(52) U.S. Cl. 290/44

(57) ABSTRACT

A method for influencing vibrations in an operating wind energy system is described. The wind energy system includes a tower including a tower top and an intermediate tower area; and a rotor and a generator arranged at the tower top. The method includes determining the vibration of the intermediate tower area of the wind energy system; and influencing the vibrations of the intermediate tower area dependent on the determined vibrations of the intermediate tower area by adjusting an operating parameter of the wind energy system.

### BACKGROUND OF THE INVENTION

The subject matter described herein relates generally to methods and systems for damping vibrations in a wind energy system, and more particularly, to methods and systems for damping vibrations in a tower of a wind energy system.

At least some known wind turbines include a tower and a nacelle mounted on the tower. A rotor is rotatable mounted to the nacelle and is coupled to a generator by a shaft. A plurality of blades extends from the rotor. The blades are oriented such that wind passing over the blades turns the rotor and rotates the shaft, thereby driving the generator to generate electricity.

Wind turbines are often arranged and adapted so that the energy yield is optimized. That means for example, the wind turbines are located at locations providing heavy winds. Further, the rotor of wind turbines can be directed in the direction where the better part of the wind comes from.

However, not only the rotor of the wind turbines is hit by the wind, but also other components such as the nacelle and the tower of the wind turbine on which the nacelle is mounted. The wind hitting components of the wind turbine may cause vibrations in the wind turbine. Besides wind, waves induce vibrations as well. The direction of excitation may be different between wind and waves. Vibrations of structural parts influence the strength and the durability of the whole wind turbine. For instance, the material of wind turbine components as well as the connection between components, such as screw connections, may weaken due to vibrations in the wind turbine.

Several damping methods are used to compensate for the vibrations of the nacelle of the wind turbine. These damping methods take into account the vibrations appearing due to the wind acting on the rotor and the machine-head (e.g. the nacelle). However, a wind turbine being located at the sea (known as an offshore wind turbine) may be exposed to conditions going beyond the mere excitations of the wind, such as sea currents, waves etc.

Thus, there is a desire to damp vibrations that are introduced to the wind turbine separately from the excitations and bending caused by the wind in the rotor plane.

### BRIEF DESCRIPTION OF THE INVENTION

In one aspect, a method for influencing vibrations in an operating wind energy system is described. The wind energy system includes a tower including a tower top and an intermediate tower area; and a rotor and a generator arranged at the tower top. The method includes determining the vibration of the intermediate tower area of the wind energy system; and influencing the vibrations of the intermediate tower area dependent on the determined vibrations of the intermediate tower area by adjusting an operating parameter of the wind energy system.

In another aspect, a method for operating a wind energy system is described. The wind energy system includes a tower including a tower top and an intermediate tower area; and a rotor providing pitch control and a generator providing generator control, wherein the rotor and the generator are arranged at the tower top. The method includes determining the vibration present at the intermediate tower area of the wind energy system; and using a combination of pitch control and generator control of the wind energy system to damp the vibrations at the intermediate tower area of the tower of the wind energy system generated other than by the wind hitting the rotor of the wind energy system substantially perpendicular.

In yet another aspect, a wind energy system is described including a tower of the wind energy system. The tower of the wind energy system includes a tower top and an intermediate tower area; a rotor including a controllable pitch and a controllable generator. The rotor as well as the generator is arranged at the tower top. The wind energy system further includes a device adapted for determining vibrations of the intermediate tower area; and a controller adapted for adjusting the controllable pitch and the controllable generator of the wind energy system. Further, the controller is connected to the device for determining vibrations of the intermediate tower area and is adapted for adjusting the control amount of the pitch control and the generator control dependent on the direction of the vibrations of the intermediate tower area.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1.

FIG. 3 is a schematic view of a wind turbine with a vibration damping system according to embodiments described herein;

FIG. 4 is a schematic view of a wind turbine with a vibration damping system according to embodiments described herein;

FIG. 5 is a flow chart of a method for damping vibrations in a wind turbine according to embodiments described herein;

FIG. 6 is a flow chart of a method for operating wind turbines according to embodiments described herein; and

FIG. 7 is a flow chart of a closed-loop damper according to embodiments described herein.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include a wind turbine system that is able to influence the vibrations of the tower of the wind energy turbine. More specifically, the systems described herein allow compensating vibrations of the tower at an intermediate height. In addition, the wind energy turbine system presented herein provides a wind energy system, which is able to influence vibrations of the tower of the wind energy system, which are caused by excitations different from the wind.

As used herein, the term tower of a wind energy system is intended to be representative of a component of a wind energy system, which supports other components of the wind energy system as well as provides the connection of the wind energy system to the ground. For instance, the tower may be mounted at its bottom-side to the ground (e.g., in a seabed) and other components (such as a nacelle) may be mounted to the tower at its top side. Typically, the tower may have a tower top and an intermediate tower area. The intermediate tower area may range from the bottom of the tower to the tower top and may typically include between about 15% to 95% of the height of the tower, more typically between about 30% to 90% of the height of the tower, and even more typically between about 50% and 90% of the height of the tower. The tower top may range from the height, where the nacelle is mounted to the tower to the intermediate tower area and may typically include about 5% to 85% of the height of the tower, more typically between about 10% to 70% of the height of the tower, and even more typically between about 10% to 50% of the height of the tower.

The term “operating parameters” as used herein should be understood as describing parameters which characterize the operation of a wind turbine. Operating parameters may refer to different components of the wind turbine, such as rotor, generator, shaft, control system, and the like. For instance, the rotation speed of the rotor is an operating parameter. Further operating parameters may be control parameters of different wind turbine components.

The term “substantially” in this context means that there may be a certain deviation from the characteristic denoted with “substantially.” For instance, “substantially perpendicular” may include deviations of some degrees, such as typically from about 1° to about 15°, more typically from about 2° to about 12°, and even more typically from about 5° to about 10° from the perpendicular arrangement. As a further example, a condition or situation being “substantially independent” from a characteristic may only be partially dependent or totally independent from the characteristic. For instance, the characteristic may only be one parameter to consider, or even only a small parameter among others, when evaluating the situation or condition being substantially independent from the characteristic.

As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power. Further, the terms “wind turbine” and “wind energy system” are synonymously used herein.

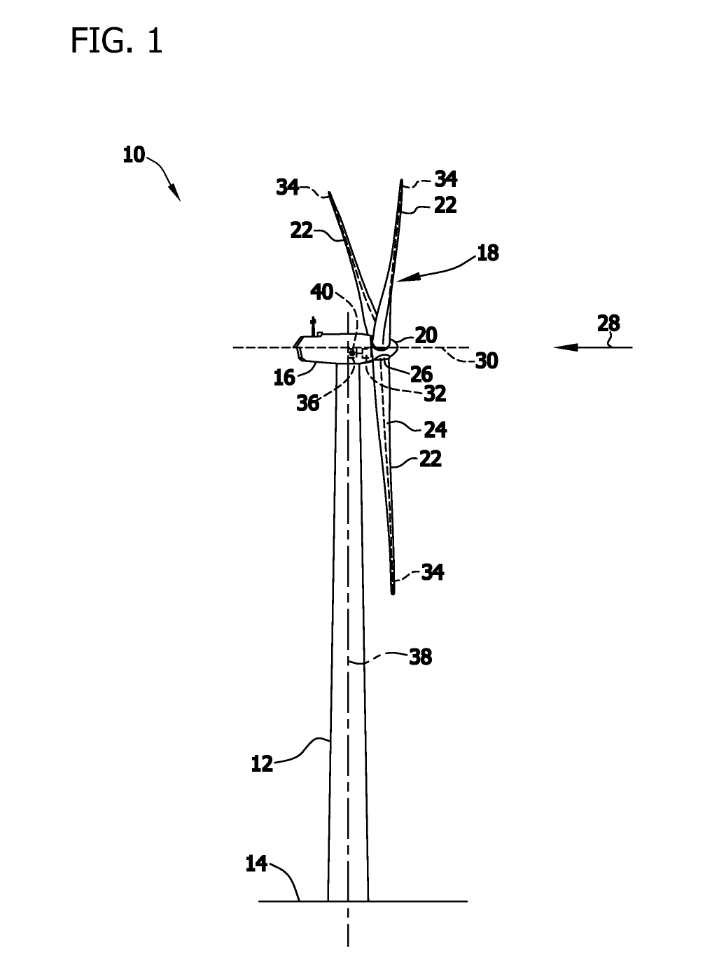

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Also, cyclic pitch control may be part of the pitch control or pitch system as referred to herein. Cyclic pitch variations influence the blade pitch angles with a phase shift of 120° to weaken the effect of load variations caused by rotor tilt and yaw errors.

Further, in the exemplary embodiment, as direction 28 changes, a yaw direction of nacelle 16 may be controlled about a yaw axis 38 to position rotor blades 22 with respect to direction 28.

In the exemplary embodiment, control system 36 is shown as being centralized within nacelle 16; however, control system 36 may be a distributed system throughout wind turbine 10, on support system 14, within a wind farm, and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface, such as a mouse and a keyboard. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands. The execution of sequences of instructions is not limited to any specific combination of hardware circuitry and software instructions.

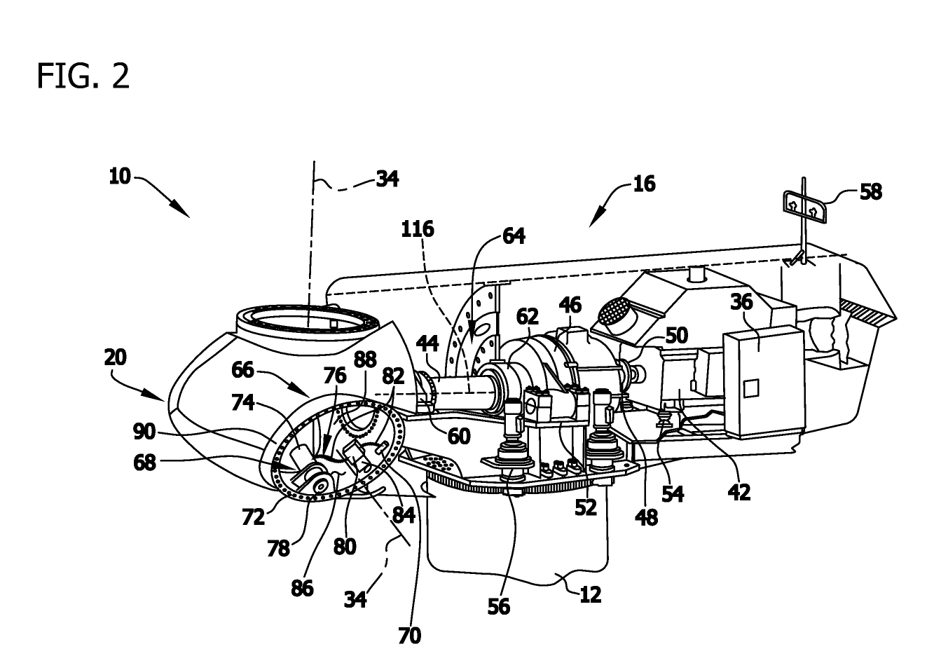

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes dual path geometry to drive high speed shaft 48. Alternatively, rotor shaft 44 is coupled directly to generator 42 with coupling 50.

Nacelle 16 also includes a yaw drive mechanism 56 that may be used to rotate nacelle 16 and hub 20 on yaw axis 38 (shown in FIG. 1) to control the perspective of rotor blades 22 with respect to direction 28 of the wind. Nacelle 16 also includes at least one meteorological mast 58 that includes a wind vane and anemometer (neither shown in FIG. 2). Mast 58 provides information to control system 36 that may include wind direction and/or wind speed. In the exemplary embodiment, nacelle 16 also includes a main forward support bearing 60 and a main aft support bearing 62.

Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and aft support bearing 62, are sometimes referred to as a drive train 64.

In the exemplary embodiment, hub 20 includes a pitch assembly 66. Pitch assembly 66 includes one or more pitch drive systems 68. Each pitch drive system 68 is coupled to a respective rotor blade 22 (shown in FIG. 1) for modulating the blade pitch of associated rotor blade 22 along pitch axis 34. Only one of three pitch drive systems 68 is shown in FIG. 2.

In the exemplary embodiment, pitch assembly 66 includes at least one pitch bearing 72 coupled to hub 20 and to respective rotor blade 22 (shown in FIG. 1) for rotating respective rotor blade 22 about pitch axis 34. Pitch drive system 68 includes a pitch drive motor 74, pitch drive gearbox 76, and pitch drive pinion 78. Pitch drive motor 74 is coupled to pitch drive gearbox 76 such that pitch drive motor 74 imparts mechanical force to pitch drive gearbox 76. Pitch drive gearbox 76 is coupled to pitch drive pinion 78 such that pitch drive pinion 78 is rotated by pitch drive gearbox 76. Pitch bearing 72 is coupled to pitch drive pinion 78 such that the rotation of pitch drive pinion 78 causes rotation of pitch bearing 72. More specifically, in the exemplary embodiment, pitch drive pinion 78 is coupled to pitch bearing 72 such that rotation of pitch drive gearbox 76 rotates pitch bearing 72 and rotor blade 22 about pitch axis 34 to change the blade pitch of blade 22.

Pitch drive system 68 is coupled to control system 36 for adjusting the blade pitch of rotor blade 22 upon receipt of one or more signals from control system 36. In the exemplary embodiment, pitch drive motor 74 is any suitable motor driven by electrical power and/or a hydraulic system that enables pitch assembly 66 to function as described herein. Alternatively, pitch assembly 66 may include any suitable structure, configuration, arrangement, and/or components such as, but not limited to, hydraulic cylinders, springs, and/or servo-mechanisms. Moreover, pitch assembly 66 may be driven by any suitable means such as, but not limited to, hydraulic fluid, and/or mechanical power, such as, but not limited to, induced spring forces and/or electromagnetic forces. In certain embodiments, pitch drive motor 74 is driven by energy extracted from a rotational inertia of hub 20 and/or a stored energy source (not shown) that supplies energy to components of wind turbine 10.

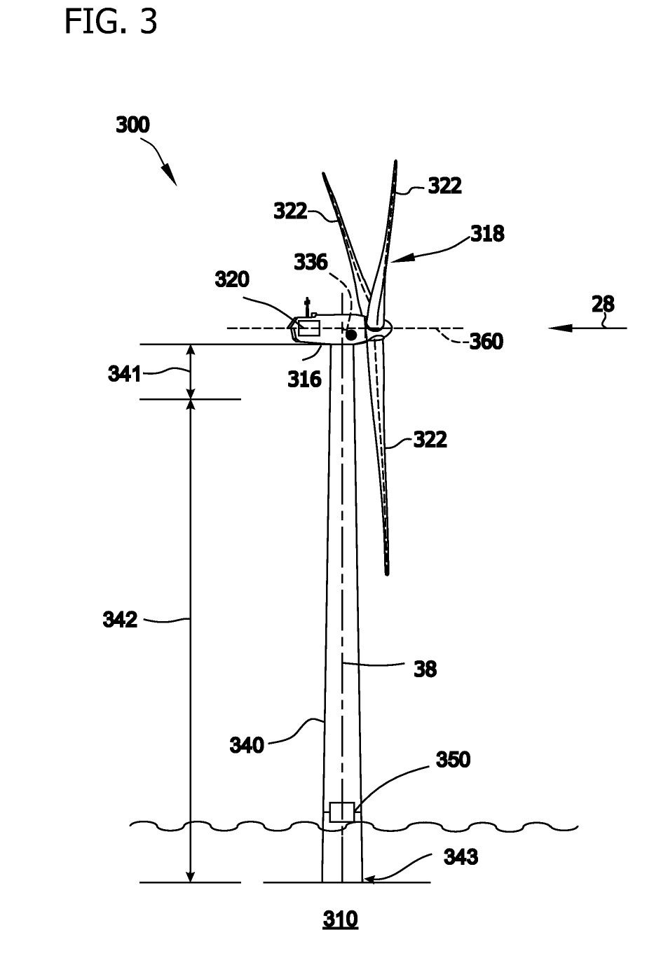

According to embodiments described herein, a wind turbine is described, which is able to compensate for vibrations in the wind turbine. For instance, vibrations of wind turbines may be excited by causes directionally aligned with the wind turbine, such as rotor mass imbalance, aero imbalance, turbulences, and causes not necessarily aligned with the wind turbine, such as waves and water currents. Typically, the excitations each have a direction and a frequency spectrum associated to them. In known wind turbines, structural damping is achieved with pitch activity driving an axial force variation. Common pitch control is used to damp tower fore-aft vibrations. That means vibrations in the direction of the longitudinal axis of the nacelle. The longitudinal axis of the nacelle may be perpendicular to the tower axis 38. In FIG. 3, the longitudinal axis is denoted with reference sign 360. Bending and nodding vibrations are usually compensated by asymmetric pitching where the force is balanced across the rotor-plane.

Side-side vibrations, such as vibrations in the cross direction of the nacelle, are damped with torque variation to the generator in the state of the art. The cross direction is perpendicular to the longitudinal axis 360 and the tower axis 38. With the generator torque variation, axial force variations damp the tower movement in axial direction.

The dampers known in the art as described above rely on sensors that are installed in the machine head or nacelle of the wind turbine. Thus, the sensors are in close proximity to the actuators for the damping measures. The tower is damped based on vibration sensors at the tower top with actuators (such as generator and pitch) at the tower top and in synchronization with the measured vibrations.

Embodiments described herein allow influencing the wind turbine vibrations independent from the origin of the vibrations. For instance, in the case that the wind energy system is an offshore wind energy system, vibrations may be introduced to the tower from waves, water currents and the like. Vibrations caused by waves, water-currents and the like are to be understood as being substantially independent from the wind direction driving the rotor of the wind energy system. As an example, vibrations generated by waves introduce vibrations to the intermediate tower area. In the case that onshore wind energy systems are used, vibrations independent from wind-induced vibrations may be shock waves, such as waves of an earthquake.

Typically, vibrations introduced independent from the wind driving the rotor of the wind energy system, are influenced by using damping methods for wind-induced vibrations. In other words, vibrations introduced independent from the wind driving the rotor can typically be influenced by a combination of damping methods for damping vibrations in the direction of the longitudinal axis of the wind energy system and methods for damping vibrations in the side-side direction of the wind energy system. For instance, vibrations of the tower top caused by the wind and originating from the tower top are compensated by damping methods like rotor control or drive train control. As an example, rotor control may include rotor related actuators, such as collective and individual pitch systems, actuated flaps, advanced flow control, and second pitch systems halfway the span of the blades. Drive train control may be provided by drive train related actuators, such as mechanical and hydraulic torque converters. According to embodiments described herein, the vibrations of the intermediate tower area may be influenced and damped by a combination of these damping methods. Typically, by combining and adjusting the control amount of operating parameters (such as collective pitch, individual pitch, and generator operation) according to the direction of the vibration, the damping of the vibration can be performed in any direction. According to embodiments described herein, the weight factor of the operating parameters used for influencing the vibrations with respect to each other will adjust the direction in which the vibrations are damped.

According to some embodiments described herein, vibrations of the wind turbine may also be compensated by adjusting the cyclic pitch in a combination of operating parameters. Typically, also vibrations at the tower top may be influenced by adjusting the cyclic pitch. Generally, the combination of adjusted operating parameters may influence the whole wind turbine, and thus, the tower top, too, even when described as being adapted for the vibrations of the intermediate tower area.

In methods according to some embodiments described herein, the vibration of the intermediate tower area of the wind energy system is determined. The vibrations of the intermediate tower area may be influenced dependent on the determined vibrations of the intermediate tower area by adjusting an operating parameter of the wind energy system.

For instance, the vibrations at the intermediate tower area may be influenced by using rotor related actuators (such as collective and/or individual pitch control) and/or drive train related actuators (such as generator control). The vibrations to be influenced may be caused by waves, water currents and the like. According to some embodiments, also vibrations of the intermediate tower area caused in the direction of the wind (for instance, vibrations of the intermediate tower area caused by the wind) may be influenced by pitch and/or generator control.

A wind energy system being able to perform the methods according to embodiments described herein can be seen in FIG. 3. The wind energy system shown in FIG. 3 may be a wind energy system as described with respect to FIGS. 1 and 2. Typically, the wind energy system 300 includes a nacelle 316, a rotor 318 having blades 322, a generator 320, a control system 336, and a tower 340, which connects the wind energy system 300 to the ground 310.

According to some embodiments described herein, the wind energy system 300 of FIG. 3 includes a tower 340 having a tower top 341 and an intermediate tower area 342. Typically, the intermediate tower area extends from the tower bottom 343 to the tower top 341, such as over about 90% of the tower length.

The rotor is able to provide pitch control, which may be performed by a control system as described above with respect to FIGS. 1 and 2. The generator 320 may provide a generator control, which also may be performed by a control system as described above.

Typically, the wind energy system includes a device for determining vibrations of the wind energy system. For instance, a device for determining vibrations of the intermediate tower area may be a vibration sensing device located in the intermediate tower area.

In FIG. 3, a vibration sensing device 350 is shown arranged in the intermediate tower area 342. According to some embodiments and in the case that an offshore wind energy system is used, the vibration sensing device may be arranged at mean sea level in order to detect the vibrations exemplarily caused by waves and water currents. In FIG. 3, the sensor 350 is approximately located at sea level, as is exemplarily shown by waves hitting the tower 340 in the intermediate tower area 341.

According to some embodiments, the device for determining vibrations in the intermediate tower area may include a decoupling device for decoupling frequencies of the wind energy system. Typically, the device for determining vibrations of the wind energy system may include one or more sensors located at the wind energy system and a decoupling device. According to some embodiments, the sensors located at the wind energy system are adapted to sense vibrations of the wind energy system, such as vibrations at the tower top (e.g. vibrations caused by the wind hitting the rotor of the wind energy system) as well as vibrations transferred from the intermediate tower area to the tower top.

The decoupling device may determine the frequencies and mode shapes of the vibrations at the tower top and at the intermediate tower area. According to some embodiments, the control system of the wind turbine may determine, dependent on the mode shapes of the vibrations, where the motion is the biggest and which damper has the largest impact on the vibration. Typically, the vibrations of the intermediate tower area and vibrations caused substantially independent from the direction of the wind driving the rotor of the wind energy system, may be gained by modelling and model based estimation of the vibrations. For instance, the control system of the wind energy system may be able to perform the modelling of the overall vibration condition of the wind energy system. In one embodiment, the control system decouples the vibration at several positions in the wind turbine and creates a matrix of magnitude and phase of the natural frequencies in the direction of the machine-head. In this way, the controller prepares control information for the actuators, so they can counteract the vibrations in the frequency and direction of the actuators. According to embodiments, the modelling may be performed by a remote calculator device (such as a computer or the like). The results of the remote calculator device may then be transmitted to the control system of the wind energy system.

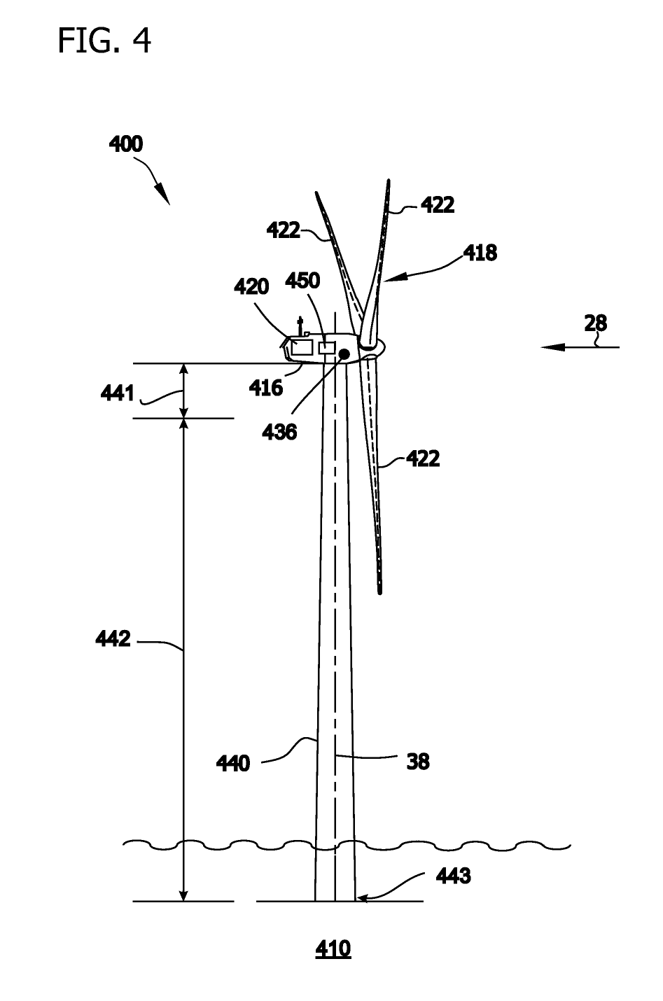

In FIG. 4, an example of a wind energy system 400 is shown providing a decoupling device 450. Typically, the wind energy system 400 includes a nacelle 416, a rotor 418 having blades 422, a generator 420, a control system 436, and a tower 440, which connects the bottom 443 of the wind energy system 400 to the ground 410.

Typically, the decoupling device may be arranged at the tower top 441 of the tower 440. The decoupling device may receive vibration data from the tower (including the tower top 441 and the intermediate tower area 442) and calculate the vibration frequencies of the tower top as well as the intermediate tower area. Typically, the decoupling device is able to determine the vibration frequencies of vibrations caused by the wind at the tower top and the vibration frequencies of vibrations caused independent from the wind, such as vibrations caused by waves and the like. Generally, the decoupling device may provide an algorithm for calculating the respective frequencies. According to some embodiments, the decoupling device determines the mode shapes. According to some embodiments, the decoupling device and/or the algorithm of the decoupling device may be part of the control system of the wind energy system.

Typically, the vibration data received either by a sensor at the intermediate tower area or the decoupling device is sent to a control system of the wind energy system. The term “control system” and “controller” are synonymously used herein.

According to some embodiments, the controller is adapted for adjusting pitch control and/or generator control of the wind energy system. That means the controller is able to calculate and send orders to the respective actuators of the wind energy system. For instance, the controller is connected to the device for determining vibrations of the wind energy system. Typically, the controller is able to receive data from the device for determining vibrations of the intermediate tower area. The controller may calculate the measures and give signals for adjusting the pitch control and/or the generator control dependent on the vibrations of the wind energy system. According to some embodiments, the controller may be adapted to calculate the amount of damping of each the pitch control and the generator control so that a combination of these damping methods can be provided, dependent on the actual situation.

According to some embodiments, the wind energy system includes a closed-loop damper in order to damp the vibrations of the tower in the intermediate tower area. Typically, the closed-loop damper may be part of the controller or control system of the wind energy system. For instance, the closed-loop damper may include the device for determining vibrations of the intermediate tower area, the controller of the wind energy system, the connection between the device for determining vibrations and the controller, and connections from the controller to the rotor and the generator. Typically, the closed-loop damper may allow exchanging information between the components being part of the closed-loop damper and may allow for interaction between the components of the closed-loop damper. An example of a closed-loop damping method is given in FIG. 7 and explained in detail with respect to FIG. 7.

Typically, the wind energy system described above may be used in a wind energy system, in which vibrations are excited separately of excitations and/or bending due to the wind in the rotor plane. According to some embodiments, the described wind energy system may be used for an offshore wind energy system, which is exposed to waves and currents of the surrounding water. In some operating ranges (for instance, at low-partial load) the waves and/or water currents may introduce vibrations that may be more dominant when compared to the wind induced vibrations. Thus, damping in the direction and frequencies of waves and water currents is advantageous. Typically, the actuation of the damping is performed by several components of the wind energy system acting as an actuator. For instance, the damping may be caused by the rotor or the drive train of the wind energy system, but the main effect of the damping may take place at sea level.

According to some embodiments, methods and devices as described herein are able to damp the vibrations at sea level in the direction and frequencies of the excitations at the intermediate tower area.

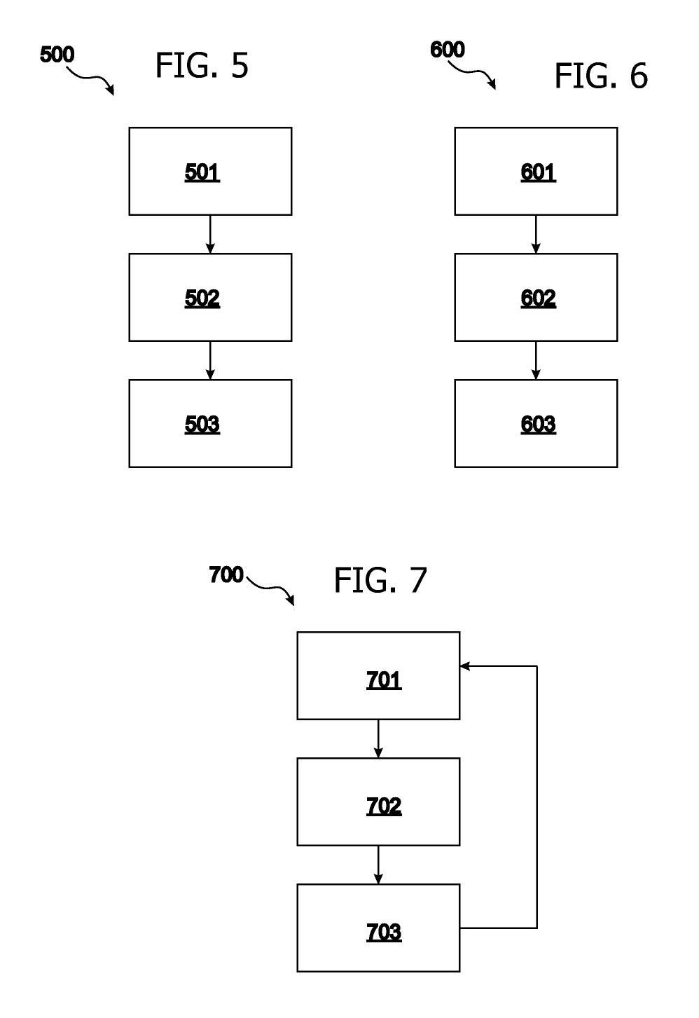

FIG. 5 shows exemplarily a flow diagram of a method for operating a wind energy system according to embodiments described herein. The method 500 allows for operating a wind energy system including a tower having a tower top and an intermediate tower area. Further, the wind energy system includes a rotor providing pitch control and a generator providing generator control, wherein the rotor and the generator are arranged at the tower top. In block 501 of method 500, the vibrations present at the intermediate tower area of the wind energy system are determined. Typically, the vibrations may be determined as described above, such as by a sensor located at the intermediate tower area or a decoupling device.

In block 502, a combination of pitch control and generator control of the wind energy system is used to damp the vibrations at the intermediate tower area of the tower of the wind energy system. Typically, the vibrations to be damped are generated independent from the direction of the wind driving the rotor of the wind energy system. That means, the vibrations and/or the bending of the tower is not induced by forces acting in the rotor plane, such as by wind hitting the rotor blades. According to some embodiments, the amount of the pitch control and the generator control in the combination of damping methods may be adapted so as to define the direction in which the damping takes place.

According to some embodiments, the methods and devices described herein allow for using damping methods and systems (such as pitch control and generator control) to influence vibrations in directions, which are independent from the direction of the wind hitting the rotor of the wind energy system. For instance, the wind hits the rotor 318 of wind energy system 300 shown in FIG. 3 substantially in the direction of the longitudinal axis 360 of the nacelle. In FIG. 3, the wind direction is indicated with arrow 28. In the case that the wind energy system is an offshore wind energy system, water currents are present and hit the tower of the wind energy system under water. However, the direction of these water currents depends on the location and the sea in which the wind energy system is mounted. Thus, the direction of the resulting vibrations being caused by water currents may be any direction. For instance, the direction of the excitation by water currents may be perpendicular to the wind direction, or may have an angle of about 0°, 10°, 20° 30°, 60°, 200°, 240°, 300° or any angle, or any angle between these example values. With embodiments described herein, it is possible to influence the vibrations of the tower independent from the direction of the excitation with the damping systems present for damping vibrations in wind direction. This is possible by using the combination of damping systems damping the vibrations in the longitudinal and the cross direction of the wind energy system. By a combination of these damping methods (for instance, pitch control for the longitudinal direction and generator control for the cross direction), vibrations in every direction can be damped. Typically, the amount of each damping method, such as rotor control and drive train control, may determine the direction of damping. In this way, it is possible to influence the damping direction by varying the amounts of pitch control and generator control in the combination of damping methods.

If vibrations in the turbine are observed, they may be measured in two planes, for-aft (i.e. in the longitudinal direction of the nacelle) and side-side (i.e. in a direction perpendicular to the longitudinal direction of the nacelle). Usual vibrations induced by the turbine itself, partially have different mode shapes and frequencies in both directions as well as different excitations in both directions. That is why dampers were developed for both directions independently. According to embodiments described herein, the turbine is experiencing excitation and, thus, vibrations that are not aligned with the classical turbine induced excitation. In order to act on the non-turbine-aligned excitation from waves and currents, one can use the existing dampers in a way that overlays a damper action scheme on top of the scheme needed for damping the turbine-induced-vibrations. In this way, each main frequency of damping action has its own direction.

One method for influencing vibrations in any direction according to embodiments of the invention is described in the flow chart of FIG. 6. The method is a method for influencing vibrations of a wind energy system as described above with respect to FIGS. 3 and 4. The method 600 includes at 601 determining the vibration of the intermediate tower area of the wind energy system. Typically, determining the vibrations may be performed by one of the above described methods, either using a sensor for sensing vibrations in several directions, or by using a decoupling device. The method 600 further includes block 602, in which the vibrations of the intermediate tower area dependent on the determined vibrations of the intermediate tower area are influenced by adjusting at least two operating parameter of the wind energy system. As described above, these two parameters are typically parameters acting in different direction on the tower, such as pitch control and generator control. Typically, by combining the parameters in a suitable way, the direction of damping can be influenced substantially independent from the direction of the wind driving the rotor of the wind energy system

In FIG. 7, a closed-loop damping method 700 is shown, as may be used for controlling the operating parameters of the wind energy system for the purpose of damping tower vibrations. In block 701, the vibrations of the tower at intermediate height are determined. Typically, an intermediate height of the tower may be any height lying between the bottom of the tower and the tower top. At 702, data gained by the determining are forwarded to the controller or control system of the wind energy system. The controller calculates the measures to be taken for compensating the vibrations of the tower. For instance, dependent on the amount and the direction of the vibrations, some operating parameters may be influenced to a greater extent than other ones (that means that a combination of the control amount of operating parameters may be adjusted in a suitable way in order to cope with the vibrations). Typically, at 703, the controller adjusts the pitch and the generator operation in a relation, which allows for compensating the determined vibration amount and direction. The determination of the vibration of the intermediate tower area continues and the circle indicated by arrows in FIG. 7 may repeat itself as long as vibrations are present in the intermediate tower area. The closed loop damper as described may control the damper in cross direction of the wind energy system and the damper in longitudinal direction of the wind energy system in such a way that the resulting damping force at a given tower height is generated.

The above-described systems and methods facilitate operating a stable wind energy system. More specifically, the wind energy system and the method according to embodiments described herein help increasing the stability and the life-time of a wind energy system by compensating vibrations excited at the intermediate tower area.

Exemplary embodiments of systems and methods for influencing vibrations of a wind energy system are described above in detail. The systems and methods are not limited to the specific embodiments described herein, but rather, components of the systems and/or steps of the methods may be utilized independently and separately from other components and/or steps described herein. For example, the method for influencing vibrations is not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for influencing vibrations in an operating wind energy system including a tower including a tower top and an intermediate tower area, wherein the wind energy system further includes a rotor and a drive train including a generator arranged at the tower top;
the method comprising:
a) determining the vibration of the intermediate tower area of the wind energy system; and,
b) influencing the vibrations of the intermediate tower area dependent on the determined vibrations of the intermediate tower area by adjusting an operating parameter of the wind energy system.

2. The method according to claim 1, wherein influencing the vibrations of the intermediate tower area includes influencing the vibrations of the intermediate tower area in several directions, substantially independent from the direction of the wind driving the rotor of the wind energy system.

3. The method according to claim 1, wherein adjusting operating parameters of the wind energy system includes adjusting a combination of at least two operating parameters of the wind energy system.

4. The method according to claim 3, wherein adjusting at least two operating parameter of the wind energy system includes adjusting an operating parameter of the rotor of the wind energy system and an operating parameter of the drive train of the wind energy system.

5. The method according to claim 1, wherein determining the vibration of the intermediate tower area is performed by at least one of the group consisting of sensing the vibration of the intermediate tower area at the intermediate tower area and decoupling the frequencies of the vibrations of the wind energy system.

6. The method according to claim 1, wherein the intermediate tower area extends from a bottom of the tower to the tower top and includes about 90% of the tower length.

7. The method according to claim 1, wherein the wind energy system is an offshore wind energy system.

8. The method according to claim 7, wherein influencing the vibrations of the intermediate tower area includes influencing the vibrations in the direction of at least one of the group consisting of waves and water currents.

9. A method for operating a wind energy system including a tower including a tower top and an intermediate tower area, wherein the wind energy system further includes a rotor adapted for pitch control and a generator adapted for generator control, wherein the rotor and the generator are arranged at the tower top;
the method comprising
a) determining the vibration present at the intermediate tower area of the wind energy system; and,
b) using a combination of pitch control and generator control of the wind energy system to damp the vibrations at the intermediate tower area of the tower of the wind energy system generated other than by the wind hitting the rotor of the wind energy system substantially perpendicular.

10. The method according to claim 9, wherein using a combination of pitch control and generator control of the wind energy system to damp the vibrations at the intermediate tower area includes influencing the vibrations of the intermediate tower area in several directions, independent from the direction of the wind hitting the rotor of the wind energy system.

11. The method according to claim 9, wherein the intermediate tower area extends from a bottom of the tower to the tower top and includes about 50% of the tower length.

12. The method according to claim 9, wherein determining the vibration of the intermediate tower area is performed by at least one of the group consisting of sensing the vibration of the intermediate tower area at the intermediate tower area and decoupling the frequencies of the vibrations of the wind energy system.

13. The method according to claim 9, wherein the wind energy system is an offshore wind energy system.

14. The method according to claim 13, wherein determining the vibration of the tower is performed by sensors located substantially at sea level in the intermediate tower area.

15. A wind energy system, comprising
a) a tower of the wind energy system including a tower top and an intermediate tower area;
b) a rotor including a controllable pitch and a controllable generator, both arranged at the tower top;
c) a device adapted for determining vibrations of the intermediate tower area; and,
d) a controller adapted for adjusting the controllable pitch and the controllable generator of the wind energy system;
wherein the controller is connected to the device for determining vibrations of the intermediate tower area and is adapted for adjusting the control amount of the controllable pitch and the controllable generator dependent on the direction of the vibrations of the intermediate tower area.

16. The wind energy system according to claim 15, wherein the intermediate tower area extends from a bottom of the tower to the tower top and includes about 90% of the tower length.

17. The wind energy system according to claim 15, wherein the device for determining vibrations of the intermediate tower area includes at least one of the group consisting of a sensor located in the intermediate tower area and a decoupling device adapted for decoupling frequencies of vibrations of the tower top and vibrations of the intermediate tower area.

18. The wind energy system according to claim 15, wherein the controller includes a closed-loop damper for damping the vibrations of the intermediate tower area.

19. The wind energy system according to claim 15, wherein the wind energy system is an offshore wind energy system.

20. The wind energy system according to claim 19, wherein the device for determining vibrations of the intermediate tower area is a sensor located in the intermediate tower area at sea level.
